(19) United States
(12) Patent Application Publication
(10) Pub. No.: US 2021/0210244 A1
(43) Pub. Date: Jul. 8, 2021

(54) RADIONUCLIDE PREPARATION SYSTEM, STORAGE MEDIUM READABLE BY COMPUTER STORING RADIONUCLIDE PREPARATION PROGRAM, RADIONUCLIDE PREPARATION METHOD, AND TERMINAL DEVICE

(71) Applicant: OSAKA UNIVERSITY, Suita-shi, Osaka (JP)

(72) Inventors: Atsushi SHINOHARA, Suita-shi (JP); Atsushi TOYOSHIMA, Suita-shi (JP); Zijian ZHANG, Suita-shi (JP); Akimitsu KANDA, Suita-shi (JP); Soichiro ICHIMURA, Suita-shi (JP)

(73) Assignee: OSAKA UNIVERSITY, Suita-shi, Osaka (JP)

(21) Appl. No.: 16/980,617

(22) PCT Filed: Mar. 1, 2019
(86) PCT No.: PCT/JP2019/008043

§ 371 Date: Sep. 14, 2020

(30) Foreign Application Priority Data
Mar. 15, 2018 (JP) 2018-048560

(51) Int. Cl. G21G 1/00; G21G 4/08

(52) U.S. Cl. CPC G21G 1/0005; G21G 2001/0094; G21K 2201/00; G21G 4/08

(57) ABSTRACT

There is provided a radionuclide manufacturing system, a computer-readable storage medium storing a radionuclide manufacturing program, a radionuclide manufacturing method, and a terminal device for more stably manufacturing a radionuclide.

A radionuclide manufacturing system includes: a heating unit configured to internally house a target holding a radionuclide; a gas supply unit; an adsorption unit configured to adsorb the radionuclide; a solvent supply unit; a storage unit configured to store a predetermined instruction; and a control unit configured to control the heating unit to heat the target at a temperature at which the radionuclide held in the target is allowed to volatilize, to control the gas supply unit to supply the carrier gas to the heating unit in order to transport the radionuclide volatilized in the heating unit to the adsorption unit, and to control the solvent supply unit in order to supply a solvent for eluting the radionuclide adsorbed to the adsorption unit to the adsorption unit based on the instruction.

### TECHNICAL FIELD

The present disclosure relates to a radionuclide manufacturing system for stably manufacturing a radionuclide from a target, a computer-readable storage medium storing a radionuclide manufacturing program, a radionuclide manufacturing method, and a terminal device.

### BACKGROUND ART

Conventionally, a method of separating and extracting a radionuclide from a target containing the radionuclide generated by using a cyclotron or the like by various methods, and for example, manufacturing a radionuclide that can be used for medical use has been known. For example, Patent Literature 1 describes a method of applying a radiation to a radium target in a cyclotron to generate ²²⁵Ac (actinium), and separating and extracting ²²⁵Ac (actinium) for medical use by using an extraction chromatograph.

Meanwhile, currently, research and development and practical application are progressing about, for example, diagnostic radiopharmaceuticals that bond a radionuclide to a compound that targets a specified organ or cell and detect and image radiation emitted from the radionuclide, and therapeutic radiopharmaceuticals that attack and destroy tumor cells and the like with the radiation emitted from the radionuclide. Moreover, expansion to not only such medical use but also various other uses is expected, such as variety improvement of agricultural products, industrial use such as semiconductor manufacturing and tire processing, dating of samples, analytical use such as non-destructive inspection, and the like. Therefore, more stable manufacturing of radionuclide is required.

### CITATION LIST

### Patent Literature

Patent Literature 1: Published Japanese Translation of PCT International Publication for Patent Application No. 2009-527731

### SUMMARY OF INVENTION

### Technical Problem

Therefore, based on the above technology, the present disclosure provides a radionuclide manufacturing system, a computer-readable storage medium storing a radionuclide manufacturing program, a radionuclide manufacturing method, and a terminal device for more stably manufacturing a radionuclide.

### Solution to Problem

According to one aspect of the present disclosure, there is provided “a radionuclide manufacturing system including: a heating unit including a first end into which carrier gas is introduced and a second end from which the carrier gas is discharged, the heating unit being configured to internally house a target holding a radionuclide; a gas supply unit including a first end connected to a gas retention unit that retains the carrier gas, and a second end connected to the first end of the heating unit; an adsorption unit including a first end connected to the second end of the heating unit and introducing the carrier gas, and a second end from which the carrier gas is discharged, the adsorption unit being configured to adsorb the radionuclide; a solvent supply unit including an end connected to the second end of the adsorption unit; a storage unit configured to store a predetermined instruction; and a control unit configured to control the heating unit to heat the target at a temperature at which the radionuclide held in the target is allowed to volatilize, to control the gas supply unit to supply the carrier gas to the heating unit in order to transport the radionuclide volatilized in the heating unit to the adsorption unit, and to control the solvent supply unit in order to supply a solvent for eluting the radionuclide adsorbed to the adsorption unit to the adsorption unit based on the instruction”.

According to one aspect of the present disclosure, there is provided “a computer-readable storage medium storing a radionuclide manufacturing program for causing a computer connected to a radionuclide manufacturing apparatus including: a heating unit including a first end into which carrier gas is introduced and a second end from which the carrier gas is discharged, the heating unit being configured to internally house a target holding a radionuclide; a gas supply unit including a first end connected to a gas retention unit that retains the carrier gas, and a second end connected to the first end of the heating unit; an adsorption unit including a first end connected to the second end of the heating unit and introducing the carrier gas, and a second end from which the carrier gas is discharged, the adsorption unit being configured to adsorb the radionuclide; and a solvent supply unit including an end connected to the second end of the adsorption unit, the computer including a storage unit configured to store a predetermined instruction to function as a control unit configured to control the heating unit to heat the target at a temperature at which the radionuclide held in the target is allowed to volatilize, to control the gas supply unit to supply the carrier gas to the heating unit in order to transport the radionuclide volatilized in the heating unit to the adsorption unit, and to control the solvent supply unit in order to supply a solvent for eluting the radionuclide adsorbed to the adsorption unit to the adsorption unit based on the instruction”.

According to one aspect of the present disclosure, there is provided “a radionuclide manufacturing method in a computer connected to a radionuclide manufacturing apparatus including: a heating unit including a first end into which carrier gas is introduced and a second end from which the carrier gas is discharged, the heating unit being configured to internally house a target holding a radionuclide; a gas supply unit including a first end connected to a gas retention unit that retains the carrier gas, and a second end connected to the first end of the heating unit; an adsorption unit including a first end connected to the second end of the heating unit and introducing the carrier gas, and a second end from which the carrier gas is discharged, the adsorption unit being configured to adsorb the radionuclide; and a solvent supply unit including an end connected to the second end of the adsorption unit, the computer including a storage unit configured to store a predetermined instruction, the radionuclide manufacturing method to be processed by a processor executing the instruction, the radionuclide manufacturing method including: a step of controlling the heating unit to heat the target at a temperature at which the radionuclide held in the target is allowed to volatilize; a step of controlling the gas supply unit to supply the carrier gas to the heating unit in order to transport the radionuclide volatilized in the heating unit to the adsorption unit; and a step of controlling the solvent supply unit in order to supply a solvent for eluting the radionuclide adsorbed to the adsorption unit to the adsorption unit”.

According to one aspect of the present disclosure, there is provided “a terminal device to be connected to a radionuclide manufacturing apparatus including: a heating unit including a first end into which carrier gas is introduced and a second end from which the carrier gas is discharged, the heating unit being configured to internally house a target holding a radionuclide; a gas supply unit including a first end connected to a gas retention unit that retains the carrier gas, and a second end connected to the first end of the heating unit; an adsorption unit including a first end connected to the second end of the heating unit and introducing the carrier gas, and a second end from which the carrier gas is discharged, the adsorption unit being configured to adsorb the radionuclide; and a solvent supply unit including an end connected to the second end of the adsorption unit, the terminal device including: a storage unit configured to store a predetermined instruction; and a control unit configured to control the heating unit to heat the target at a temperature at which the radionuclide held in the target is allowed to volatilize, to control the gas supply unit to supply the carrier gas to the heating unit in order to transport the radionuclide volatilized in the heating unit to the adsorption unit, and to control the solvent supply unit in order to supply a solvent for eluting the radionuclide adsorbed to the adsorption unit to the adsorption unit based on the instruction”.

### Advantageous Effects of Invention

The present disclosure can provide a radionuclide manufacturing system, a computer-readable storage medium storing a radionuclide manufacturing program, a radionuclide manufacturing method, and a terminal device for more stably manufacturing a radionuclide.

Note that the above-described effect is illustrative for convenience of description and is not restrictive. In addition to or in place of the above-described effect, it is also possible to produce any effect described in the present disclosure and an effect apparent to a person skilled in the art.

### BRIEF DESCRIPTION OF DRAWINGS

FIG. 1 is a diagram conceptually illustrating extraction of a radionuclide to be used in a radionuclide manufacturing system according to the present disclosure.

FIG. 2 is a diagram illustrating an overall configuration of the radionuclide manufacturing system according to the present disclosure.

FIG. 3 is a block diagram illustrating a configuration example of the radionuclide manufacturing system according to the present disclosure.

FIG. 4 is a diagram illustrating a flow of a manufacturing process to be executed by the radionuclide manufacturing system according to the present disclosure.

FIG. 5 is a diagram illustrating a processing flow to be executed by a processor of the radionuclide manufacturing system according to the present disclosure.

FIG. 6 is a diagram illustrating timing of operations of respective components in the radionuclide manufacturing system according to the present disclosure.

FIG. 7a is a diagram illustrating an operation example of the radionuclide manufacturing system according to the present disclosure.

FIG. 7b is a diagram illustrating an operation example of the radionuclide manufacturing system according to the present disclosure.

FIG. 7c is a diagram illustrating an operation example of the radionuclide manufacturing system according to the present disclosure.

FIG. 7d is a diagram illustrating an operation example of the radionuclide manufacturing system according to the present disclosure.

FIG. 7e is a diagram illustrating an operation example of the radionuclide manufacturing system according to the present disclosure.

FIG. 8 is a diagram conceptually illustrating a radiation dose detected by a first sensor of the radionuclide manufacturing system according to the present disclosure.

FIG. 9 is a diagram conceptually illustrating a radiation dose detected by a second sensor of the radionuclide manufacturing system according to the present disclosure.

### DESCRIPTION OF EMBODIMENTS

Various embodiments of the present disclosure will be described with reference to the accompanying drawings. Note that common components in the drawings are denoted with the same reference signs.

### First Embodiment

1. Outline of Radionuclide Manufacturing System According to the Present Disclosure

The radionuclide manufacturing system according to the present disclosure is a system for extracting a radionuclide from a target that internally holds the radionuclide by, for example, applying radiation in a cyclotron for collection as a radionuclide-containing solution.

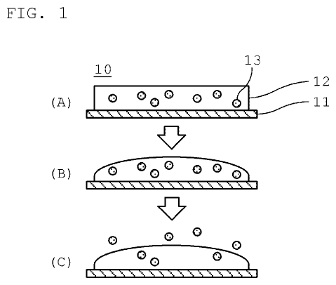

FIG. 1 is a diagram conceptually illustrating extraction of the radionuclide to be used in the radionuclide manufacturing system according to the present disclosure. Specifically, FIG. 1 is a diagram illustrating a principle that a radionuclide 13 is extracted from a target plate 10 including a target 12 internally holding the radionuclide 13 and a metal supporting foil 11 supporting the target 12 by application of radiation in a cyclotron.

To begin with, with reference to FIG. 1(A), the target plate 10 is prepared including, for example, the target 12 that internally holds the radionuclide 13 by applying high-energy radiation accelerated by an accelerator such as a cyclotron, and the metal supporting foil 11 supporting the target 12. Then, when the target plate 10 is heated to a temperature exceeding the melting point of a metal constituting the target 12, the target 12 is melted as illustrated in FIG. 1(B). Next, when the target plate 10 is further heated to a temperature that exceeds the boiling point of the radionuclide and reaches a temperature at which the internally held radionuclide can move to a surface of the target 12 by thermal vibration of the metal constituting the target 12, as illustrated in FIG. 1(C), the radionuclide volatilizes from the melted target 12 into a gas. The radionuclide manufacturing system according to the present disclosure finally obtains a desired radionuclide-containing solution by eluting the volatilized radionuclide into a solvent for collection.

In the present disclosure, the radionuclide 13 may be any radionuclide as long as the radionuclide has the boiling point higher than the melting point of the target 12. Furthermore, the radionuclide 13 may emit either of α rays, β rays, and γ rays, and as one example, the radionuclide 13 includes ⁶⁷Ga, ^{99m}Tc, ¹¹¹In, ¹²³I, ¹³¹I, ²⁰¹Tl, ^{81m}Kr, ¹⁸F, ⁸⁹Sr, ⁹⁰Y, ²²³Ra, ⁵⁹Fe, and ²¹¹At. Of these radionuclides, depending on the use, the radionuclide 13 can be appropriately selected from viewpoints of the half-life and the type of radiation to be emitted, and for example, when used for medical use, ²¹¹At and the like can be used.

The target 12 can be appropriately selected from known targets compatible with the desired radionuclide 13 as long as the target has the melting point lower than the boiling point of the desired radionuclide 13. For example, ²⁰⁹Bi can be used as the target 12 for ²¹¹At exemplified as the radionuclide.

As one example, ²⁰⁹Bi (bismuth) is used as the target 12 in separating ²¹¹At (astatin) as the radionuclide 13. For the Bi target, as one example, Bi is evaporated in a vapor deposition apparatus at a predetermined thickness (for example, 5 to 30 mg/cm²) onto a tantalum metal board to which an aluminum foil is attached at a predetermined thickness (for example, 10 μm). Next, this Bi target is placed in the AVF cyclotron and a rays are applied to the Bi target. This makes it possible to obtain a Bi target that internally holds ²¹¹At. Note that the method is merely one example, and any method may be used as long as a desired target can be obtained.

2. Configuration of Radionuclide Manufacturing System According to the Present Disclosure

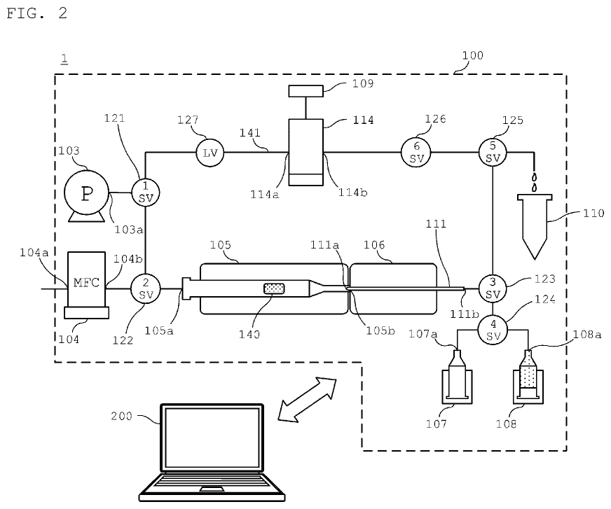

FIG. 2 is a diagram illustrating an overall configuration of a radionuclide manufacturing system 1 according to the present disclosure. With reference to FIG. 2, the radionuclide manufacturing system 1 includes a radionuclide manufacturing apparatus 100 for heating a target 140 holding a radionuclide and collecting the volatilized radionuclide, and a terminal device 200 for controlling the radionuclide manufacturing apparatus 100. Note that the radionuclide manufacturing system 1 does not need to include all components illustrated in FIG. 2. Part of the components may be omitted, and other components may be added. For example, in a preceding stage of the radionuclide manufacturing apparatus 100, it is possible to further include an accelerator for manufacturing the target 140 and a carrying device for carrying the target 140 into the radionuclide manufacturing apparatus 100. In a later stage, it is also possible to further include a packaging device for packaging the manufactured radionuclide-containing solution in a carrying container.

Note that in the present disclosure, even if terms such as “connect”, “link”, and “bond” are used in the description of each component, these terms do not only mean that each component is to “connect”, “link”, or “bond” each other “directly.” That is, this may include “connect”, “link”, or “bond” with each other “indirectly” in a sense with another component sandwiched therebetween, without any particular indication.

With reference to FIG. 2, the radionuclide manufacturing apparatus 100 includes a pump 103, a mass flow controller (MFC) 104, a tubular furnace 105, a heater 106, a gas syringe pump 107, a solvent syringe pump 108, an adsorption tube 111, a filter 114, a first valve 121 to a sixth valve 126, and a leak valve 127. These components are connected to each other by a conduit 141 and also connected to the terminal device 200 via a control line and a data line. Note that although not specifically illustrated in FIG. 2, the radionuclide manufacturing apparatus 100 further includes a first sensor 131 to a third sensor 133 that detect various information items to be processed by the terminal device 200.

The pump 103 includes an end 103a connected to a first end 105a of the tubular furnace 105 via the first valve 121 and the second valve 122. The pump 103 functions as a suction unit for bringing the inside of the conduit 141, the tubular furnace 105, and the adsorption tube 111 into a vacuum state in an evacuation process.

The mass flow controller 104 includes a first end 104a connected to a tank retaining a carrier gas (gas retention unit) and a second end 104b connected to the first end 105a of the tubular furnace 105 via the second valve 122. The carrier gas and an exhaust gas are introduced from the second end 104b into the conduit 141. The mass flow controller 104 can control not only on-off of supply of the carrier gas and the exhaust gas but also a supply amount and a mixing ratio of the gas. In the present disclosure, the mass flow controller 104 functions as a gas supply unit for supplying the carrier gas and the exhaust gas to the tubular furnace 105.

Note that any desired carrier gas can be used as the carrier gas depending on the radionuclide. As one example, He and/or O₂ is used. In particular, when a mixture of He and O₂ is used, a volume ratio of He to O₂ is preferably 99:1 to 51:49, more preferably 90:10 to 60:40, and further preferably 80:20 to 70:30. When the volume ratio is within the above range, an increase in the yield of radionuclide is expected.

The carrier gas preferably contains a predetermined amount of H₂O from the viewpoint of improving the yield of radionuclide. The amount of H₂O contained is 1 to 15 μg/cm³, preferably 2 to 10 μg/cm³, and more preferably 5 to 8 μg/cm³.

Furthermore, depending on the size of the target 140 used, the size of the tubular furnace 105 used, and/or the thickness of the conduit 141 used, and the like, the flow rate of the carrier gas is preferably 5 to 40 mL/min, more preferably 1 to 30 mL/min, and further preferably 1.5 to 25 mL/min from the viewpoint of improving the yield of radionuclide.

As the exhaust gas, it is possible to appropriately use a desired gas according to the radionuclide. As one example, He and/or O₂ is used, and preferably He is used.

The tubular furnace 105 includes the first end 105a connected to the end 103a of the pump 103 and the second end 104b of the mass flow controller 104 via the first valve 121 and/or the second valve 122, and a second end 105b connected to a first end 111a of the adsorption tube 111. The carrier gas and the exhaust gas are introduced from the first end 105a into the tubular furnace 105, and discharged from the second end 105b to the outside of the tubular furnace 105. The tubular furnace 105 internally houses the target 140, and functions as a heating unit that heats the target 140 at a temperature at which the radionuclide held by the target 140 can volatilize.

The heating temperature can be appropriately determined according to the boiling point of the desired radionuclide, that is, a temperature at which the target 140 can volatilize. As one example, from the viewpoint of improving the yield of radionuclide, the heating temperature is preferably 600 to 850° C., more preferably 700 to 850° C., and further preferably 800 to 850° C. Note that in manufacturing ²¹¹At, the heating temperature is preferably 600 to 850° C., more preferably 700 to 850° C., and further preferably 800 to 850° C.

The heater 106 is disposed to cover at least part of the adsorption tube 111 connected to the second end 105b of the tubular furnace 105. The heater 106 includes, for example, a ribbon heater, and is wound around the adsorption tube 111 from an end of the adsorption tube 111 on the tubular furnace 105 side (that is, first end 111a), leaving an adsorption area where the radionuclide is adsorbed. Note that the heater 106 can also be used by being connected to a temperature controller for on-off and temperature control.

The heater 106 functions as a warming unit that covers part of the adsorption tube 111 from the end of the adsorption tube 111 on the tubular furnace 105 side (that is, first end 111a), and warms the covered adsorption tube 111 and the radionuclide that passes through the adsorption tube 111. The solvent is supplied to the adsorption area of the adsorption tube 111 to elute the radionuclide. At this time, if the tubular furnace 105 and the adsorption area are in direct contact with each other, the solvent may evaporate by the tubular furnace 105 heated to a high temperature. The heater 106 functioning as the warming unit prevents this evaporation. Therefore, the temperature at which the heater 106 performs warming is determined in consideration of the temperature at which the radionuclide is adsorbed as a liquid or a solid and the temperature at which the solvent evaporates. The temperature is preferably 50 to 600° C., more preferably 80 to 200° C., and further preferably 100 to 150° C. Note that in manufacturing ²¹¹At, the temperature is preferably 50 to 600° C., more preferably 80 to 200° C., and further preferably 100 to 150° C.

The adsorption tube 111 includes the first end 111a connected to the second end 105b of the tubular furnace 105, and a second end 111b connected to the syringe pumps 107 and 108 and a collection container 110 via the third valve 123 to the fifth valve 125. The carrier gas and the exhaust gas are introduced from the first end 111a into the adsorption tube 111, and discharged from the second end 111b to the outside of the adsorption tube 111. The solvent is introduced from the second end 111b and is discharged from the second end 111b again by the exhaust gas. As one example, the adsorption tube 111 includes a Teflon tube, a glass tube, a quartz tube, or the like. The adsorption tube 111 includes a warming area that is covered with the heater 106 from the first end 111a side and is warmed to a desired temperature, and the adsorption area where the radionuclide (gas) transported by the carrier gas from the tubular furnace 105 becomes a solid and is adsorbed to a wall surface of the adsorption area. Therefore, the adsorption tube 111 functions as an adsorption unit that adsorbs the radionuclide that is volatilized in the tubular furnace 105 and is transported by the carrier gas. Note that in the warming area warmed by the heater 106, the radionuclide is not adsorbed or is harder to adsorb than in the adsorption area. In the present embodiment, the adsorption area is not warmed by the heater 106, but can be warmed or cooled from the viewpoint of yield and stability.

The gas syringe pump 107 and the solvent syringe pump 108 include ends 107a and 108a respectively connected to the second end 111b of the adsorption tube 111 via the third valve 123 and the fourth valve 124. Both the syringe pumps 107 and 108 function as a solvent supply unit that extrudes a certain amount of solvent supplied from the solvent syringe pump 108 by the gas supplied from the gas syringe pump 107 and transports the solvent to the adsorption area of the adsorption tube 111.

Note that in the present disclosure, the gas syringe pump 107 and the solvent syringe pump 108 are provided separately, but in order to function as the solvent supply unit, either one can be adopted as long as a certain amount of solvent can be transported to the adsorption area. That is, it is not necessary to use the syringe pumps separately, integrated one may be used, or a solvent supply device other than the syringe pump may be used.

The solvent to be supplied to the adsorption tube 111 can be appropriately selected according to the radionuclide to be adsorbed. The solvent is preferably sodium hydroxide, hydrochloric acid, nitric acid, alcohol such as ethanol or methanol, other organic solvent, physiological saline solution, or distilled water, and more preferably physiological saline solution and distilled water. The amount of the solvent to be supplied depends on the amount of the radionuclide held in the target 140 and the thickness of the adsorption tube 111. From the viewpoint of improving the yield of the radionuclide, the amount of the solvent is preferably 1 to 1000 μL, more preferably 10 to 500 μL, and further preferably 50 to 200 μL.

The gas to be supplied from the gas syringe pump 107 may contain the same component as in the carrier gas or the exhaust gas, or other gas, for example, air can be used.

The filter 114 includes a first end 114a connected to the end 103a of the pump 103 via the leak valve 127 and the first valve 121, and a second end 114b connected to the second end 111b of the adsorption tube 111 via the third valve 123 and the like. When the carrier gas or the like in the conduit 141 is discharged from a discharge port 109, the filter 114 functions as a filter unit that removes nuclide residues and the like carried with the carrier gas. As the filter 114, a column or the like containing anhydrous sodium sulfate, activated carbon, and the like can be used alone or in appropriate combination.

Note that although the collection container 110 does not necessarily have to be included as one of components of the radionuclide manufacturing system 1 according to the present disclosure, the collection container 110 is disposed in a later stage of the adsorption tube 111, and functions as a collection unit for collecting the radionuclide eluted in the solvent. One example of the collection container 110 is an Eppendorf tube, but the collection container 110 can be appropriately selected according to the amount and type of radionuclide or solvent.

One example of the first valve 121 to the sixth valve 126 and the leak valve 127 is an electromagnetic valve, an electric valve, or a valve to which an electric motor is connected. Any valve can be used as long as the valve can be controlled by receiving a signal from the terminal device 200. In the present disclosure, three-way valves are used for the first valve 121 to the fifth valve 125. The first valve 121 controls the connection between the second valve 122 and the pump 103 or the leak valve 127.

The second valve 122 controls the connection between the tubular furnace 105 and the mass flow controller 104 or the first valve 121.

Third valve 123 controls the connection between the adsorption tube 111 and the fourth valve 124 or the fifth valve 125.

The fourth valve 124 controls the connection between the third valve 123 and the gas syringe pump 107 or the solvent syringe pump 108.

The fifth valve 125 controls the connection between the third valve 123 and the collection container 110 or the sixth valve 126. Two-way valves are used for the sixth valve 126 and the leak valve 127.

The sixth valve 126 controls the connection between the fifth valve 125 and the filter 114.

The leak valve 127 controls the connection between the first valve 121 and the filter 114.

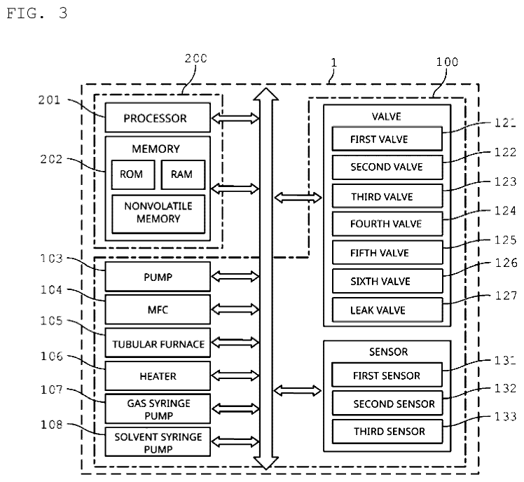

Note that the configuration of the terminal device 200 will be described in detail in FIG. 3.

FIG. 3 is a block diagram illustrating a configuration example of the radionuclide manufacturing system according to the present disclosure. With reference to FIG. 3, in addition to the pump 103, the mass flow controller 104, the tubular furnace 105, the heater 106, the gas syringe pump 107, the solvent syringe pump 108, the first valve 121 to the sixth valve 126, and the leak valve 127 described in detail in FIG. 2, the radionuclide manufacturing system 1 includes the terminal device 200 and the first sensor 131 to the third sensor 133. These components are electrically connected to each other via a control line and a data line.

Note that the radionuclide manufacturing system 1 does not need to include all the components illustrated in FIG. 3, and can have a configuration in which part of the components may be omitted, and other components may be added. Note that some components illustrated in FIG. 2 are not illustrated in FIG. 3.

While the terminal device 200 includes at least a processor 201 and a memory 202, the terminal device 200 may appropriately include an input interface for inputting various settings of the radionuclide manufacturing apparatus 100 (touch panel, keyboard, and the like), a display for displaying set information, detected information, and the like, a communication interface for transmitting and receiving setting information and detected information to and from remotely installed another terminal device and server device (neither is illustrated). One example of the terminal device 200 is a laptop computer, a desktop computer, and the like, but any terminal device capable of executing a program according to the present disclosure may be used.

The processor 201 includes a CPU (microcomputer), and functions as a control unit that outputs a control signal to other connected components and controls the components based on various programs stored in the memory 202. The processor 201 performs processing for executing an instruction stored in the memory 202, that is, a radionuclide manufacturing program or OS according to the present disclosure. Note that the processor 201 may include a single CPU, or may include a combination of a plurality of CPUs.

The memory 202 includes a RAM, a ROM, or a nonvolatile memory (HDD in some cases), and functions as a storage unit. The ROM stores instructions for controlling the radionuclide manufacturing system and instructions for executing an OS as a program. The RAM is a memory to be used for writing and reading data while the program stored in the ROM is processed by the processor 201. The nonvolatile memory is a memory for writing and reading data by executing the program, and the data written in the nonvolatile memory is saved even after the execution of the program is finished. As one example, radiation dose data and pressure data detected by the first sensor 131 to the third sensor 133 are stored.

The first sensor 131 is disposed in or near the adsorption area of the adsorption tube 111. The first sensor 131 functions as a first detection unit that detects the radiation dose emitted from the radionuclide that is volatilized from the target 140, transported by the carrier gas, and adsorbed to the adsorption tube 111. The first sensor 131 can include a known radiation dose detector according to the type of radiation emitted by the radionuclide. As one example of the first sensor 131, a Geiger-Muller counter tube, a scintillator, a photodiode, or the like can be used. The Geiger-Muller counter tube and the scintillator are preferable from the viewpoint of detecting the radiation dose more accurately. The radiation dose detected by the first sensor 131 is output to the terminal device 200 and stored in the memory 202. The radiation dose can also be processed by the processor 201 and used as a trigger for starting a liquid sending process.

The second sensor 132 is disposed in or near the adsorption tube 111. More specifically, the second sensor 132 is disposed in or near the adsorption area where the radionuclide is adsorbed in the adsorption tube 111. The second sensor 132 functions as a second detection unit for detecting that the solvent is extruded by the gas supplied from the gas syringe pump 107, passes through the adsorption area of the adsorption tube 111, and reaches the warming area. More specifically, when the radionuclide is transported in the direction of the warming area by the solvent, the radiation dose in the adsorption area decreases. The second sensor 132 is used for determining the arrival and passage of the solvent to the adsorption area by detecting the radiation dose. The second sensor 132 can include a known radiation dose detector according to the type of radiation emitted by the radionuclide. As one example of the second sensor 132, a Geiger-Muller counter tube, a scintillator, a photodiode, or the like can be used. A lower-priced photodiode is preferred because the accuracy of the radiation dose detected is less required than in the first sensor 131. The radiation dose detected by the second sensor 132 is output to the terminal device 200 and stored in the memory 202. The radiation dose can also be processed by the processor 201 and used as a trigger for starting an air supply process. Note that in the present embodiment, both the first sensor 131 and the second sensor 132 are provided, but only one of the first sensor 131 and the second sensor 132 can function similarly.

The third sensor 133 is disposed by connection to any position from the first valve 121 to the sixth valve 126 in the conduit 141. The third sensor 133 functions as a third detection unit for detecting the air pressure inside the conduit 141. The air pressure detected by the third sensor 133 is output to the terminal device 200 and stored in the memory 202. The air pressure can also be processed by the processor 201 and used as a trigger for starting an aeration process or a separation process.

Note that the pump 103, the mass flow controller 104, the tubular furnace 105, the heater 106, the gas syringe pump 107, the solvent syringe pump 108, the first valve 121 to the sixth valve 126, and the leak valve 127 have been described in detail in FIG. 2, and thus descriptions thereof will be omitted here.

3. Radionuclide Manufacturing Method According to the Present Disclosure

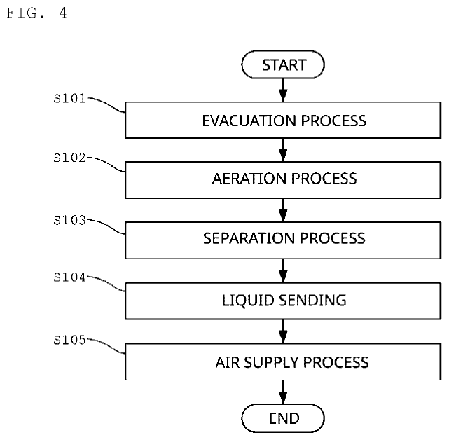

FIG. 4 is a diagram illustrating a flow of a manufacturing process to be executed by the radionuclide manufacturing system according to the present disclosure. Specifically, FIG. 4 illustrates an outline of a radionuclide manufacturing method to be executed by the radionuclide manufacturing system by the processor 201 processing the radionuclide manufacturing program according to the present disclosure.

The radionuclide manufacturing method according to the present disclosure is started after disposing, in the tubular furnace 105, the target 140 internally holding the radionuclide by application of a high-energy radiation accelerated in an accelerator. With reference to FIG. 4, the pump 103 executes the evacuation process (S101) of bringing the inside of the conduit 141, the tubular furnace 105, and the adsorption tube 111 of the radionuclide manufacturing apparatus 100 into a vacuum state. Then, when the inside of the conduit 141 and the like goes into a vacuum state with air pressure equal to or lower than predetermined air pressure, the aeration process (S102) of supplying the carrier gas from the mass flow controller 104 to the tubular furnace 105 is executed. Next, when the carrier gas is supplied and the air pressure inside the conduit 141 or the like becomes the atmospheric pressure, in the tubular furnace 105, the separation process (S103) of heating the target 140 at a temperature at which the radionuclide can volatilize to volatilize the radionuclide from the target 140 is executed. In the separation process, the volatilized radionuclide is transported to the adsorption tube 111 by the carrier gas, and the radionuclide is adsorbed to the adsorption area of the adsorption tube 111. Next, when the radionuclide is adsorbed to the adsorption tube 111, the liquid sending process (S104) of extruding a certain amount of solvent supplied in advance from the solvent syringe pump 108 by the gas supplied from the gas syringe pump 107 and sending the solvent to the adsorption area of the adsorption tube 111 is executed. Finally, the air supply process (S105) of extruding the radionuclide eluted in the sent solvent to the collection container 110 by the exhaust gas supplied from the mass flow controller 104 and collecting the solvent in which the radionuclide is eluted in the collection container 110 is executed.

Through the above processes, the radionuclide is manufactured as the radionuclide-containing solution in which the radionuclide separated from the target 140 is eluted.

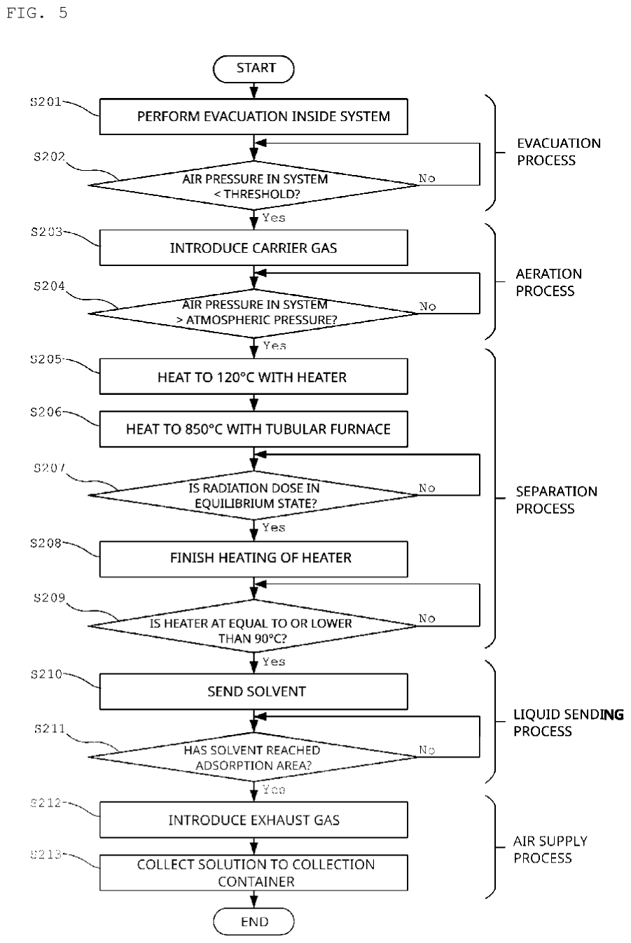

FIG. 5 is a diagram illustrating a processing flow to be executed by the processor of the radionuclide manufacturing system according to the present disclosure. Specifically, FIG. 5 illustrates a processing flow to be mainly executed by the processor 201 outputting a control signal to each component of the radionuclide manufacturing apparatus 100 to control each component in the radionuclide manufacturing method illustrated in FIG. 4.

As described in FIG. 4, the radionuclide manufacturing method is started after disposing, in the tubular furnace 105, the target 140 internally holding the radionuclide by application of a high-energy radiation accelerated in an accelerator.

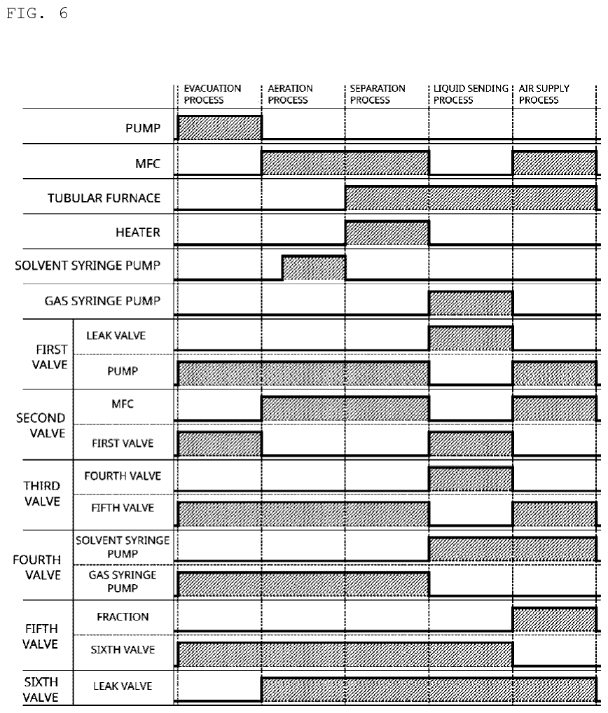

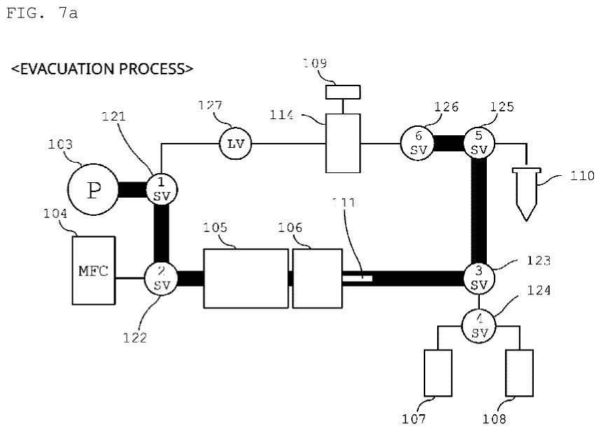

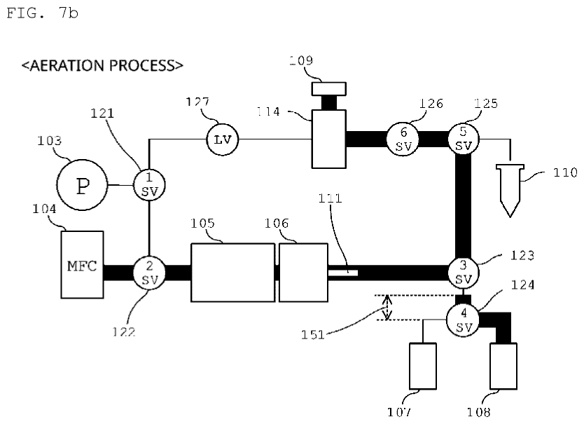

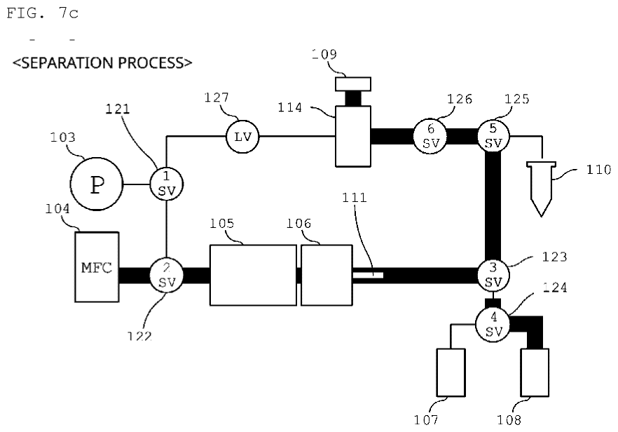

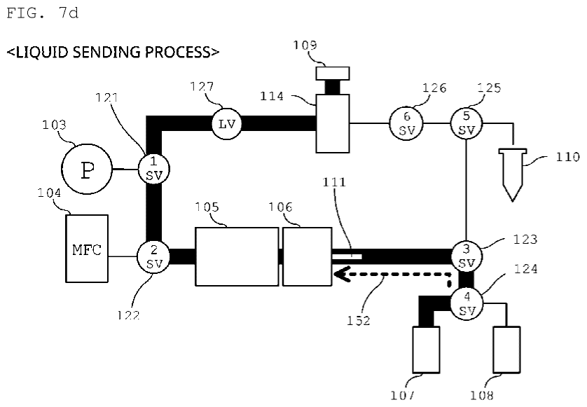

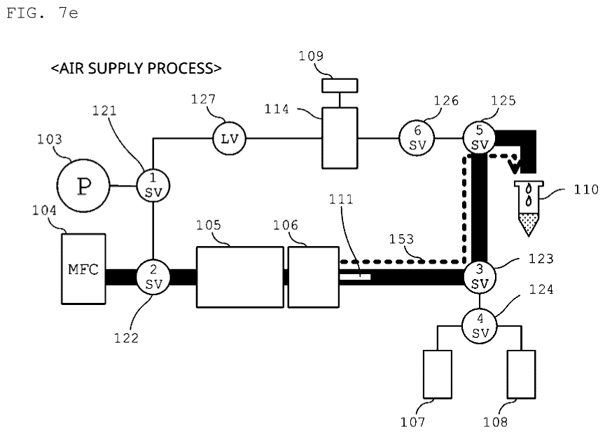

Here, FIG. 6 is a diagram illustrating timing of operations of respective components in the radionuclide manufacturing system according to the present disclosure. Specifically, FIG. 6 is a diagram illustrating on-off timing of operations of respective components when a control signal is output from the processor 201. FIGS. 7a to 7e are diagrams illustrating operation examples of the radionuclide manufacturing system according to the present disclosure. Specifically, FIGS. 7a to 7e each illustrate a connection relationship of respective components that changes when the components operate at the timing illustrated in FIG. 6. Note that FIG. 7 illustrates that each component operates (or valve opens) when the vertical axis is “high”, and each component does not operate (or valve closes) when the vertical axis is “low”. That is, in FIG. 7, each component operates (or valve opens) at timing of hatching with diagonal lines.

<Evacuation Process>

With reference to FIG. 6, in the evacuation process, the processor 201 controls the first valve 121 to connect between the pump 103 and the second valve 122, and closes the sixth valve 126. That is, as illustrated in FIG. 7a, the processor 201 controls each component to form a system in which the pump 103, the first valve 121, the second valve 122, the tubular furnace 105, the adsorption tube 111, the third valve 123, the fifth valve 125, and the sixth valve 126 are connected to each other. With reference to FIG. 5 again, the processor 201 turns on the pump 103 and starts evacuation inside the system illustrated in FIG. 7a (S201). Next, the processor 201 monitors the air pressure detected by the third sensor 133, and determines whether the system has gone into a vacuum state, that is, whether the air pressure in the system is equal to or lower than a predetermined threshold (S202). The processor 201 repeats the above determination at predetermined intervals until the air pressure becomes equal to or lower than the threshold. Then, when the processor 201 determines that the air pressure has become equal to or lower than the threshold, the evacuation process is finished.

<Aeration Process>

The processor 201 finishes the evacuation process based on the air pressure detected by the third sensor 133 in S202, and controls the mass flow controller 104 to start supplying the carrier gas into the tubular furnace 105 (aeration process). Specifically, with reference to FIG. 6, the processor 201 controls the second valve 122 to connect between the mass flow controller 104 and the tubular furnace 105, and controls the sixth valve 126 to connect between the filter 114 and the fifth valve 125. That is, as illustrated in FIG. 7b, the processor 201 controls each component to form a system in which the mass flow controller 104, the second valve 122, the tubular furnace 105, the adsorption tube 111, the third valve 123, the fifth valve 125, the sixth valve 126, the filter 114, and the discharge port 109 are connected to each other. With reference to FIG. 5 again, the processor 201 controls the mass flow controller 104 to introduce the carrier gas into the system (S203). Next, the introduction of the carrier gas increases the air pressure in the system. The processor 201 monitors the air pressure detected by the third sensor 133, and determines whether the increased air pressure is lower than the atmospheric pressure (S204). The processor 201 repeats the above determination at predetermined intervals until the air pressure becomes equal to or higher than the atmospheric pressure. Then, when the processor 201 determines that the air pressure becomes equal to or higher than the atmospheric pressure, the aeration process is finished.

Here, in the aeration process, as illustrated in FIG. 6, in parallel with the introduction of the carrier gas, the processor 201 controls the solvent syringe pump 108 to prepare a predetermined amount (for example, 100 μL) of solvent to be supplied to the adsorption tube 111. Specifically, as illustrated in FIG. 7b, the processor 201 controls the solvent syringe pump 108 to extrude the predetermined amount (arrow 151) from the fourth valve 124 in the direction of the third valve 123. Note that the solvent may be prepared in the aeration process, or at any time if prepared in advance before the liquid sending process. That is, it is possible to prepare the solvent, for example, in the evacuation process or the separation process.

<Separation Process>

The processor 201 finishes the aeration process based on the air pressure detected by the third sensor 133 in S204, and controls the tubular furnace 105 to start heating the target 140 (separation process). With reference to FIG. 6, an open-close state of each valve in the separation process is the same as in the aeration process. Therefore, as illustrated in FIG. 7c, a system is formed in which the mass flow controller 104, the second valve 122, the tubular furnace 105, the adsorption tube 111, the third valve 123, the fifth valve 125, the sixth valve 126, the filter 114, and the discharge port 109 are connected to each other. With reference to FIG. 5 again, the processor 201 turns on the operation of the heater 106 to warm the adsorption tube 111 to a predetermined temperature (for example, 120° C.) (S205). Also, the processor 201 turns on the operation of the tubular furnace 105 to heat the target 140 at a temperature at which the radionuclide can volatilize (S206).

Here, the mass flow controller 104 remains on, and the carrier gas is continuously supplied from the mass flow controller 104 into the system. Therefore, the radionuclide that is volatilized by heating in the tubular furnace 105 and separated from the target 140 is transported by the carrier gas to the adsorption area of the adsorption tube 111. At this time, since a part of the adsorption tube 111 on the tubular furnace 105 side (warming area) is warmed by the heater 106, the radionuclide is not adsorbed to the warming area. Meanwhile, the adsorption area on the collection container side of the warming area is maintained at a temperature at which the radionuclide becomes solid. Therefore, the radionuclide (gas) transported by the carrier gas is cooled in the adsorption area and adsorbed to an inner wall of the adsorption area.

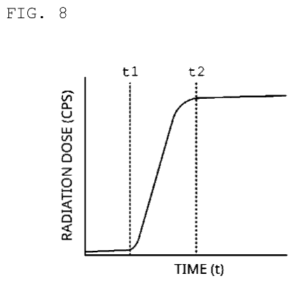

Next, the processor 201 monitors the radiation dose detected by the first sensor 131. Here, FIG. 8 is a diagram conceptually illustrating the radiation dose detected by the first sensor 131 of the radionuclide manufacturing system according to the present disclosure. As illustrated in FIG. 8, when the separated radionuclide begins to be transported by the carrier gas to the adsorption unit 111 (FIG. 8: t1), the radiation dose detected by the first sensor 131 increases over time (FIG. 8: t1 to t2). Then, when the radionuclide is completely separated from the target 140 and all the radionuclide is transported to the adsorption tube 111, the radiation dose reaches an equilibrium state (FIG. 8: t2 or later). That is, the processor 201 can determine whether the radiation dose has reached equilibrium by calculating the inclination of the radiation dose increase curve (differentiation) at predetermined intervals and determining whether the inclination is equal to or less than a predetermined inclination (generally zero). With reference to FIG. 5 again, the processor 201 monitors the radiation dose detected by the first sensor 131 and determines whether the radiation dose has reached an equilibrium state (S207). The processor 201 repeats the above determination at predetermined intervals until the radiation dose reaches an equilibrium state. Then, when the processor 201 determines that the radiation dose has reached an equilibrium state, the warming of the heater 106 is finished (S208). Then, the processor 201 determines whether the temperature of the heater 106 has cooled to a temperature at which the solvent is not evaporated (for example, 90° C.) (S209). The processor 201 repeats the determination until the temperature reaches the above temperature. Then, when the processor 201 determines that the temperature has reached the above temperature, the introduction of the carrier gas is stopped and the separation process is finished.

<Liquid Sending Process>

The processor 201 finishes the separation process based on the radiation dose detected by the first sensor 131 in S207, and controls the gas syringe pump 107 to start supplying the solvent (liquid sending process). Specifically, with reference to FIG. 6, the processor 201 controls the first valve 121 to connect between the leak valve 127 and the second valve 122, controls the third valve to connect between the adsorption tube 111 and the fourth valve 124, controls the fourth valve to connect between the third valve 123 and the gas syringe pump 107, and further controls the leak valve 127 to connect between the first valve 121 and the filter 114. That is, as illustrated in FIG. 7d, the processor 201 connects each component to form a system in which the gas syringe pump 107, the fourth valve 124, the third valve 123, the adsorption tube 111, the tubular furnace 105, the second valve 122, the first valve 121, the leak valve 127, the filter 114, and the discharge port 109 are connected to each other.

Then, the processor 201 controls the gas syringe pump 107 to supply the gas into the formed system. With this configuration, a predetermined amount of solvent prepared on the third valve 123 side of the fourth valve 124 in the aeration process is extruded in the direction of the adsorption tube 111 by the gas supplied from the gas syringe pump 107 (arrow 152 of FIG. 7d), and the predetermined amount of solvent is supplied to the adsorption tube 111 (S210). At this time, while the supplied solvent passes through the adsorption area of the adsorption tube 111, the radionuclide adsorbed in the separation process is eluted in the solvent. Then, when all of the solvent reaches and passes through the adsorption area, a decrease in the radiation dose detected by the second sensor 132 disposed in the adsorption area reaches an equilibrium state.

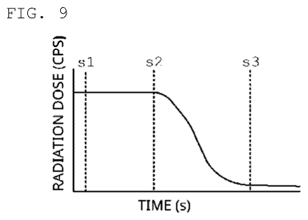

Here, FIG. 9 is a diagram conceptually illustrating the radiation dose detected by the second sensor of the radionuclide manufacturing system according to the present disclosure. As illustrated in FIG. 9, in a stage (s1) when sending the solvent is started, since the solvent has not yet reached the adsorption area of the adsorption tube 111, the radiation dose detected by the second sensor 132 maintains the radiation dose immediately after the separation process. Subsequently, in a stage (s2) when the solvent reaches the adsorption area, the radionuclide is eluted into the solvent and is transported together with the solvent in the direction of the warming area of the adsorption tube 111. Then, the radiation dose detected by the second sensor 132 decreases with time after s2. Then, as a result of all the solvent reaching the adsorption area and being transported in the direction of the warming area, the decrease in the radiation dose reaches equilibrium (s3). That is, the processor 201 can determine whether the decrease in the radiation dose has reached equilibrium by calculating the inclination of the radiation dose decrease curve (differentiation) at predetermined intervals and determining whether the inclination is equal to or less than a predetermined inclination (generally zero). With reference to FIG. 5 again, based on whether the decrease in the radiation dose detected by the second sensor 132 has reached equilibrium, the processor 201 determines whether the solvent has completely reached and passed through the adsorption area of the adsorption tube 111 (S211). The processor 201 repeats the above determination at predetermined intervals until determination that the solvent has completely passed. Then, on determination that the solvent has completely passed, the processor 201 stops the operation of the gas syringe pump 107, and the liquid sending process is finished.

<Air Supply Process>

The processor 201 finishes the liquid sending process based on the radiation dose detected by the second sensor 132 in S211, and controls the mass flow controller 104 to start the supply of the exhaust gas (air supply process). Specifically, with reference to FIG. 6, the processor 201 controls the second valve 122 to connect between the mass flow controller 104 and the tubular furnace 105, controls the third valve 123 to connect between the adsorption tube 111 and the fifth valve 125, and controls the fifth valve 125 to connect between the third valve 123 and the conduit on the collection container 110 side. That is, as illustrated in FIG. 7e, the processor 201 controls each component to form a system in which the mass flow controller 104, the second valve 122, the tubular furnace 105, the adsorption tube 111, the third valve 123, the fifth valve 125, and the tube on the collection container 110 side are connected to each other. Then, the processor 201 controls the mass flow controller 104 to introduce the exhaust gas into the system (S212).

The exhaust gas introduced from the mass flow controller 104 exists in the warming area of the adsorption tube 111, and extrudes the solvent in which the radionuclide is eluted in the direction of the collection container 110. Therefore, the solvent in which the radionuclide is eluted passes through the system illustrated in FIG. 7e and is discharged from the conduit on the collection container 110 side to the collection container 110 (S213). With this configuration, finally, the radionuclide is manufactured as the radionuclide-containing solution.

Note that in the present disclosure, although the radionuclide has been finally manufactured as the radionuclide-containing solution, the solution may be further concentrated or diluted to prepare the radionuclide-containing solution having a higher or lower concentration. Another active ingredient may be appropriately added to the obtained radionuclide-containing solution. That is, the obtained radionuclide-containing solution can be appropriately prepared and processed into a desired form according to its use.

As described above, in the present embodiment, through control by the processor 201, each component of the radionuclide manufacturing apparatus 100 is operated to manufacture the radionuclide. This makes it possible to manufacture the radionuclide more stably. Each manufacturing process is switched based on the radiation dose and air pressure detected by the first sensor 131 to the third sensor 133. This makes it possible to manufacture the radionuclide more accurately and stably.

### Second Embodiment

The first embodiment has described a case where timing of switching each manufacturing process is determined based on the radiation dose and air pressure detected by the first sensor 131 to the third sensor 133. The second embodiment will describe a case where a radionuclide manufacturing apparatus 100 includes a timer instead of the first sensor 131 to the third sensor 133. Note that the present embodiment is similar to the first and second embodiments in configuration, process, and procedure, except for items to be specifically described below. Therefore, detailed description of these items will be omitted.

In the present embodiment, as described above, the radionuclide manufacturing apparatus 100 includes a timer. The timer functions, for example, as a time measuring unit that measures time from the start of each manufacturing process. A processor 201 determines whether the measured time has exceeded a predetermined time.

Specifically, in the first embodiment, in S202 of the processing flow illustrated in FIG. 5, it is determined whether the air pressure in the system has reached a threshold. However, in the present embodiment, the timer measures the time since the evacuation in the system (S201) is started, and the processor 201 determines whether the time has exceeded a previously calculated time needed to bring the inside of the system into a vacuum state. Then, when it is determined that the measured time has exceeded the previously calculated time, the processor 201 controls a mass flow controller 104 to introduce carrier gas (S203).

In addition, in the first embodiment, it is determined in S204 of the processing flow illustrated in FIG. 5 whether the air pressure in the system has reached the atmospheric pressure. However, in the present embodiment, the timer measures a time from the start of the introduction of the carrier gas into the system (S203), and the processor 201 determines whether the time has exceeded a previously calculated time needed to bring the inside of the system into the atmospheric pressure. Then, when it is determined that the measured time has exceeded the previously calculated time, the processor 201 controls a heater 106 to start warming (S205).

In the first embodiment, in S207 of the processing flow illustrated in FIG. 5, it is determined whether the radiation dose detected near the adsorption area of the adsorption tube 111 has reached an equilibrium state. However, in the present embodiment, the timer measures a time from the start of heating in the tubular furnace 105 (S206), and the processor 201 determines whether the measured time has exceeded the previously calculated time needed to reach an equilibrium state. Then, when it is determined that the measured time has exceeded the previously calculated time, the processor 201 controls the heater 106 to finish the warming (S208).

In the first embodiment, in S211 of the processing flow illustrated in FIG. 5, it is determined whether all the solvent has reached the adsorption area based on the radiation dose detected near the adsorption area. However, in the present embodiment, the timer measures a time from the start of the supply of the solvent by the gas syringe pump 107 (S210), and the processor 201 determines whether the time has exceeded a previously calculated arrival time. Then, when it is determined that the measured time has exceeded the previously calculated time, the processor 201 controls the gas syringe pump 107 to finish the supply of the solvent.

As described above, in a similar manner to the first embodiment, in the present embodiment, through control by the processor 201, each component of the radionuclide manufacturing apparatus 100 is operated to manufacture the radionuclide. This makes it possible to manufacture the radionuclide more stably. Also, the switching of each manufacturing process has been determined based on a comparison between the previously calculated time and the time measured by the timer. This makes it possible to manufacture the radionuclide more accurately and stably.

<Others>

Note that it is also possible to construct the system by combining elements described in each embodiment as appropriate or replacing the elements.

The process and procedure described in this specification can be implemented by not only those explicitly described in the embodiments, but also software, hardware, or a combination of software and hardware. Specifically, the process and procedure described in this specification are implemented by mounting logic corresponding to the process in a medium such as an integrated circuit, a volatile memory, a nonvolatile memory, a magnetic disk, and an optical storage. The process and procedure described in this specification can be mounted as a computer program and executed by various computers including a terminal device.

Even if it is described that the process and procedure described in this specification are executed by a single device, component, or module, such a process or procedure can be executed by a plurality of devices, a plurality of components, and/or a plurality of modules. Even if it is described that various information items described in this specification are stored in a single memory or storage unit, such information items can be stored in a distributed manner in a plurality of memories provided in a single device or a plurality of memories provided in a plurality of devices in a distributed manner. Furthermore, elements of hardware described in this specification can be implemented by integrating the elements in fewer components or by breaking the elements down into more elements.

### REFERENCE SIGNS LIST

1 radionuclide manufacturing system
100 radionuclide manufacturing apparatus
200 terminal device

1. A radionuclide manufacturing system comprising:
a heating unit including a first end into which carrier gas is introduced and a second end from which the carrier gas is discharged, the heating unit being configured to internally house a target holding a radionuclide;
a gas supply unit including a first end connected to a gas retention unit that retains the carrier gas, and a second end connected to the first end of the heating unit;
an adsorption unit including a first end connected to the second end of the heating unit and introducing the carrier gas, and a second end from which the carrier gas is discharged, the adsorption unit being configured to adsorb the radionuclide;
a solvent supply unit including an end connected to the second end of the adsorption unit;
a storage unit configured to store a predetermined instruction; and
a control unit configured to control the heating unit to heat the target at a temperature at which the radionuclide held in the target is allowed to volatilize, to control the gas supply unit to supply the carrier gas to the heating unit in order to transport the radionuclide volatilized in the heating unit to the adsorption unit, and to control the solvent supply unit in order to supply a solvent for eluting the radionuclide adsorbed to the adsorption unit to the adsorption unit based on the instruction.

2. The radionuclide manufacturing system according to claim 1, further comprising a warming unit disposed to cover a part of the adsorption unit and configured to warm the radionuclide transported by the carrier gas.

3. The radionuclide manufacturing system according to claim 2, wherein the control unit is configured to control the warming unit to warm the part covered with the warming unit to a temperature at which the solvent does not volatilize.

4. The radionuclide manufacturing system according to claim 1, further comprising a suction unit including an end connected to the heating unit and configured to bring the heating unit into a vacuum state.

5. The radionuclide manufacturing system according to claim 4, wherein the control unit is configured to control the suction unit to bring the heating unit into a vacuum state.

6. The radionuclide manufacturing system according to claim 1, further comprising a first detection unit configured to determine timing for supplying the solvent to the adsorption unit.

7. The radionuclide manufacturing system according to claim 6, wherein
the first detection unit is disposed in or near the adsorption unit, and
the control unit is configured to control the solvent supply unit to supply the solvent to the adsorption unit based on a radiation dose detected by the first detection unit.

8. The radionuclide manufacturing system according to claim 1, further comprising a second detection unit configured to determine timing for supplying exhaust gas from the gas supply unit to the adsorption unit in order to discharge the solvent to a collection unit for collecting the solvent in which the radionuclide is eluted.

9. The radionuclide manufacturing system according to claim 8, wherein
the second detection unit is disposed in or near the adsorption unit, and
the control unit is configured to control the gas supply unit to supply the exhaust gas to the adsorption unit based on a radiation dose detected by the second detection unit.

10. The radionuclide manufacturing system according to claim 1, wherein the target includes Bi or bismuth.

11. The radionuclide manufacturing system according to claim 1, wherein the radionuclide includes ²¹¹At or astatine.

12. A computer-readable storage medium storing a radionuclide manufacturing program for causing
a computer connected to a radionuclide manufacturing apparatus including: a heating unit including a first end into which carrier gas is introduced and a second end from which the carrier gas is discharged, the heating unit being configured to internally house a target holding a radionuclide; a gas supply unit including a first end connected to a gas retention unit that retains the carrier gas, and a second end connected to the first end of the heating unit; an adsorption unit including a first end connected to the second end of the heating unit and introducing the carrier gas, and a second end from which the carrier gas is discharged, the adsorption unit being configured to adsorb the radionuclide; and a solvent supply unit including an end connected to the second end of the adsorption unit, the computer including a storage unit configured to store a predetermined instruction
to function as a control unit configured to control the heating unit to heat the target at a temperature at which the radionuclide held in the target is allowed to volatilize, to control the gas supply unit to supply the carrier gas to the heating unit in order to transport the radionuclide volatilized in the heating unit to the adsorption unit, and to control the solvent supply unit in order to supply a solvent for eluting the radionuclide adsorbed to the adsorption unit to the adsorption unit based on the instruction.

13. A radionuclide manufacturing method in a computer connected to a radionuclide manufacturing apparatus including: a heating unit including a first end into which carrier gas is introduced and a second end from which the carrier gas is discharged, the heating unit being configured to internally house a target holding a radionuclide; a gas supply unit including a first end connected to a gas retention unit that retains the carrier gas, and a second end connected to the first end of the heating unit; an adsorption unit including a first end connected to the second end of the heating unit and introducing the carrier gas, and a second end from which the carrier gas is discharged, the adsorption unit being configured to adsorb the radionuclide; and a solvent supply unit including an end connected to the second end of the adsorption unit, the computer including a storage unit configured to store a predetermined instruction,
the radionuclide manufacturing method to be processed by a processor executing the instruction,
the radionuclide manufacturing method comprising:
a step of controlling the heating unit to heat the target at a temperature at which the radionuclide held in the target is allowed to volatilize;
a step of controlling the gas supply unit to supply the carrier gas to the heating unit in order to transport the radionuclide volatilized in the heating unit to the adsorption unit; and
a step of controlling the solvent supply unit in order to supply a solvent for eluting the radionuclide adsorbed to the adsorption unit to the adsorption unit.

14. A terminal device to be connected to a radionuclide manufacturing apparatus comprising: a heating unit including a first end into which carrier gas is introduced and a second end from which the carrier gas is discharged, the heating unit being configured to internally house a target holding a radionuclide; a gas supply unit including a first end connected to a gas retention unit that retains the carrier gas, and a second end connected to the first end of the heating unit; an adsorption unit including a first end connected to the second end of the heating unit and introducing the carrier gas, and a second end from which the carrier gas is discharged, the adsorption unit being configured to adsorb the radionuclide; and a solvent supply unit including an end connected to the second end of the adsorption unit,
the terminal device comprising:
a storage unit configured to store a predetermined instruction; and
a control unit configured to control the heating unit to heat the target at a temperature at which the radionuclide held in the target is allowed to volatilize, to control the gas supply unit to supply the carrier gas to the heating unit in order to transport the radionuclide volatilized in the heating unit to the adsorption unit, and to control the solvent supply unit in order to supply a solvent for eluting the radionuclide adsorbed to the adsorption unit to the adsorption unit based on the instruction.
